(19) United States
(12) Patent Application Publication
(10) Pub. No.: US 2012/0290361 A1
(43) Pub. Date: Nov. 15, 2012

(54) SYSTEM AND METHOD FOR EFFICIENTLY ESTIMATING A RELIABLE PRICE ELASTICITY OF DEMAND USING THE JOINT DEMAND MODEL

(76) Inventors: Eric Hills, (US); Joo Nipko, (US); Lee Rehwinkel, Austin, TX (US); Jorgen Harmse, Austin, TX (US)

(21) Appl. No.: 13/523,263

(22) Filed: Jun. 14, 2012

Related U.S. Application Data
(63) Continuation-in-part of application No. 12/276,033, filed on Nov. 21, 2008.

(51) Int. Cl. G06Q 10/00

(52) U.S. Cl. 705/7.35

(57) ABSTRACT

The present invention relates to a system and method for efficiently estimating the sensitivity, or elasticity, of customer demand to changes in price in a business-to-business market environment. More particularly, this method relies on a parametric demand model, and a corresponding offer model which is referred to as the Joint Demand Model. This model is used to estimate the elasticity of market segments using win-only transactional data. In addition, this invention provides a method for efficiently calculating the estimation error of the estimated elasticity, and uses such estimation error in a weighting scheme based on a hierarchical model in order to produce a reliable estimate of elasticity.

This application is a continuation in part of U.S. application Ser. No. 12/276,033, filed on Nov. 21, 2008, which is incorporated herein by reference.

### BACKGROUND

In contrast to business-to-consumer markets where product prices are usually set by the business and are not negotiated with a customer, prices for products in business-to-business markets are usually determined through negotiations between the business and the customer. In such circumstances, a customer often approaches a salesperson with a request for a price quote on one or more specific products. The salesperson, knowing certain attributes about the customer and the order, will respond with an offer price. The customer can then either accept or reject the offer. If the offer is accepted, an order is recorded within the company's transaction database. If the offer is rejected, usually no data about the rejected offer is recorded by the salesperson or added to the company's sales transaction database. As a result, the company's transaction database does not capture any information regarding the rejected offers. Therefore, the data recorded when an offer is accepted by a customer in a business-to-business market is often described as win-only transaction data.

Businesses must make a number of important decisions based upon their expectation of how customers will respond to price offers and changes in price offers. These decisions are sometimes built upon demand models which help predict a customer's response or sensitivity to price changes, also known as elasticity. Elasticity of demand provides a measure of the change in quantity demanded of a good or service based on changes in its price and is often used in demand models. Such predictions can help a business determine the optimal price for a product. In modeling customer behavior, businesses often employ mathematical models in the form of a parametric demand models. These parametric demand models are motivated by microeconomic theory and describe the behavior of customers under certain assumptions. In order to apply a parametric demand model, transaction data is typically used to estimate the parameters of the model. Such an approach is only useful if the sales process which generates transaction data conforms to the assumptions of the demand model. Since business-to-business markets are characterized by negotiations between the sales person and the customer, the application of business-to-consumer models are often found to be unreliable because they fail to incorporate the negotiation aspect of the market.

In addition, unlike business-to-consumer markets in which transaction data is usually plentiful, business-to-business markets are often characterized by a fewer number of sales transactions, even though a larger total number of goods may be included in those transactions. As a result of the fewer number of transactions, the amount of data used to estimate the demand model parameters in business-to-business markets is often sparse, which leads to unreliable estimates of elasticity. Using unreliable demand model parameters to determine an optimal pricing strategy can lead to pricing recommendations that result in a lost sale and therefore have a negative financial impact on a business. Therefore, it is important that any estimate of elasticity be reliable, where we define reliability as being resistant to sparse data and outlier transactions.

Accordingly, the present invention relates to a system and method for efficiently estimating reliable elasticities to be used in a demand model for predicting customer demand for a product in a business-to-business market.

### SUMMARY

The present invention relates to a system and method for efficiently estimating the sensitivity, or elasticity, of customer demand to changes in price in a business-to-business market environment. It provides a computer-implemented product pricing system and method for optimizing product pricing recommendations. More particularly, the present invention is a computer implemented system and method for efficiently estimating reliable elasticities in a business-to-business market. It includes a system and method for calculating customer demand, segmenting markets using win-only transaction data, and efficiently providing a reliable estimate of elasticity based on a market segment hierarchy, estimated customer demand model parameters and the uncertainty in the estimated customer demand model parameters. It uses this reliable estimate of elasticity in a price optimization algorithm that computes product price recommendations by market segment.

Although other types of demand models may be used, the present method uses a parametric demand model, and a corresponding offer model which is referred to herein as the Joint Demand Model or JDM. The Joint Demand Model describes win-only transaction data more completely than models employed in business-to-consumer markets as the model incorporates the negotiation aspect of business-to-business markets. The particular embodiment of the Joint Demand Model in the present invention lends itself to an efficient method and system for estimating the demand model's parameters, as well as calculating the estimation error of the parameters. The estimation error can then be used within a weighting scheme based on a hierarchical model in order to produce a reliable estimate of elasticity.

Further, the computer implemented system described in the present invention addresses computational inefficiencies in using traditional parameter estimation techniques in estimating the parameters of the Joint Demand Model. More specifically, the present invention uses a moment matching technique as the mathematical foundation of the numerically efficient algorithm for estimating the parameters of the Joint Demand Model. In addition, the method calculates the parameter estimation error, and provides a methodology for using the estimation error to improve the reliability of the elasticity estimates using a hierarchical weighting scheme.

One embodiment of a joint demand model is set forth in U.S. patent application Ser. No. 12/276,033, incorporated by reference in its entirety herein, which discloses a computer implemented method for jointly computing one or more pricing recommendations for a business using both a demand and offer distribution model.

The present invention comprises a computer-implemented method for determining optimized product pricing recommendations. The method is implemented by computer-executable instructions being executed by a computer processor. Sales transaction data stored in memory for one or more products is inputted. The sales transaction data comprises observed win-only sales transactions for a business. Market segments that have similar responses to product price changes are computed by ranking market segment attributes using price sensitivity data and the sales transaction data. Using the market segment ranking, the market segments are grouped into a market segment hierarchy. A set of estimated model parameters is computed for each market segment in the market segment hierarchy. Using a moment matching algorithm, the market segments, the sales transaction data and the estimated model parameters, a customer demand model with customer demand model parameters is computed for the market segment in the market segment hierarchy and storing the customer demand model parameters in a data storage system. An estimation error for the customer demand model parameters is computed for the market segment in the market segment hierarchy and stored. Initial demand elasticity for the market segment in the market segment hierarchy is computed using the customer demand model parameters. A reliable elasticity estimate for the market segment is computed at a lowest level in the market segment hierarchy using the computed initial demand elasticity and customer demand model parameter estimation error. Optimized price recommendations are computed using a price optimizer algorithm that includes the reliable elasticity estimate and the optimized price recommendations are displayed to a user.

### BRIEF DESCRIPTION OF DRAWINGS

These and other features, aspects and advantages of the present invention will become better understood with regard to the following description, appended claims, and accompanying drawings wherein:

FIG. 1 depicts a computer system and network suitable for implementing the system and method for determining price recommendations;

FIG. 2 is a representation of the typical database structure of win-only-transaction data;

FIG. 3 is a functional block diagram illustrating a computer implemented system and method for determining pricing recommendations;

FIG. 4 depicts a functional block diagram for generating a joint demand model parameter lookup table;

FIG. 5 is a representation of the database table structure of the joint demand model parameters lookup table;

FIG. 6 is a functional block diagram illustrating the detail of the elasticity estimator;

FIG. 7 is a flow diagram of the various steps required to estimate elasticities using the joint demand model and a lookup table;

FIG. 8 is an example of a segmentation hierarchy used in a weighting scheme to calculate reliable elasticities;

FIG. 9 is a graphical depiction of an exemplary willingness-to-pay distribution;

FIG. 10 is a graphical depiction of an exemplary offer distribution; and

FIG. 11 is a graphical depiction of an exemplary implied transaction density.

FIG. 12 is a flow diagram of an exemplary embodiment of the method for determining optimized product price recommendations.

### DETAILED DESCRIPTION OF INVENTION

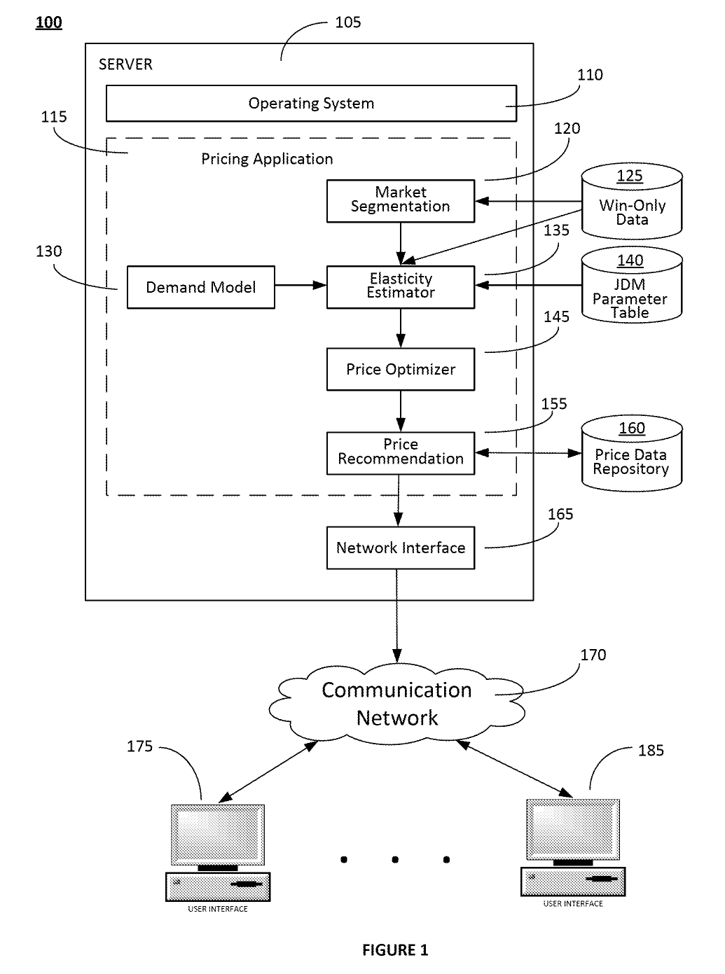

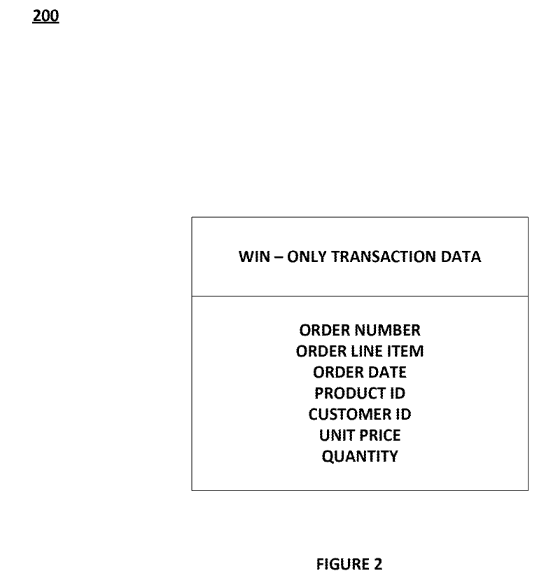

FIG. 1 depicts a computer system and network 100 suitable for implementing the system and method for determining price recommendations. A server computer 105 includes an operating system 110 for controlling the overall operation of the server 105, which connects to user interface devices 175, 185 via a server/network interface 165 and a communication network 170. A software-implemented pricing application 115 resides in the server 105 and accesses win-only transaction data 125 and joint demand model parameter table data 140 from data storage devices for use by a market segmentation function 120, an elasticity estimator 135 and a price optimizer 145, respectively. The elasticity estimator 135 also receives data from a demand model 130. A price recommendation function 155 receives data from the price optimizer 145, may store price recommendations in a price data repository 160, and communicates the price recommendations to user interface devices 175, 185 via a network interface 165 and a communication network 170. FIG. 2 represent the typical database table structure of win-only transaction data. Typically the data consists of identification attributes such as the order number, the order line item, the order date, the product identifier, and the customer identifier. Metrics such as the unit price the product was sold for and the quantity of units sold are typically present.

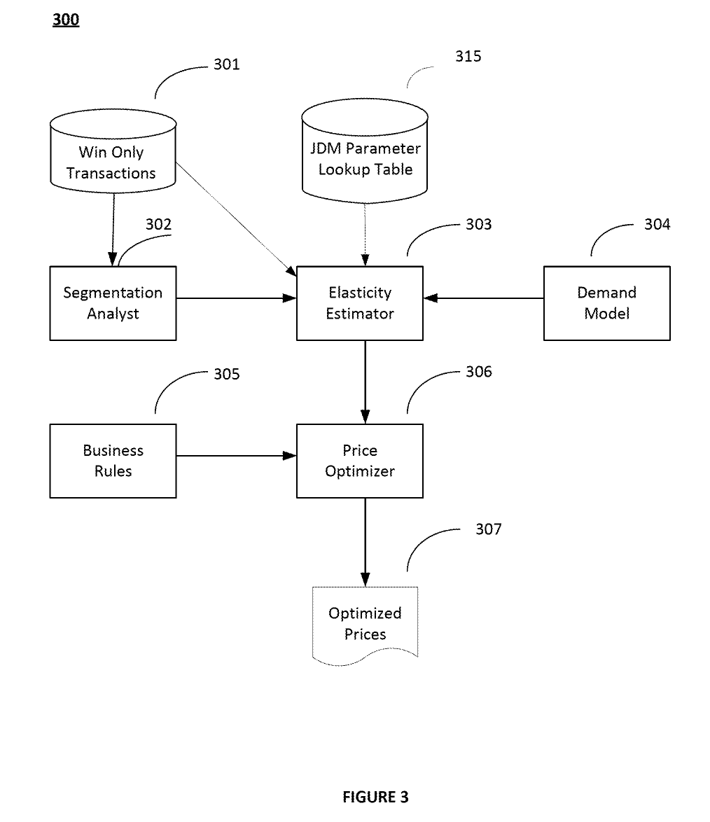

FIG. 3 is a functional block diagram illustrating a computer implemented system and method for determining pricing recommendations 300. Win-only transactions data 301 is used to perform segmentation analysis 302 where each market segment is defined by a collection of product, customer, order, and geographical attributes. Each market segment is considered to have the same response to price changes, where the attributes selected for use in market segmentation can be determined through a number of methods, included but not limited to a statistical analysis of historical transactions. The win-only transactions data 301 is also used by an elasticity estimator 304. The elasticity estimator 304 uses the win-only transaction data 203, in conjunction with an assumed demand model 303 to calculate elasticities 304 for each market segment. The demand model 303 may be the Joint Demand Model that includes both an offer model and a demand model. The price optimizer 306 uses the output from the elasticity estimator 304 in conjunction with business rules 305 to determine optimized prices 307. The optimization may be formulated as a Profit or Revenue maximizing objective, where the demand model is used within the optimization problem to determine the expected number of units sold from either an increase or decrease in a market segments price.

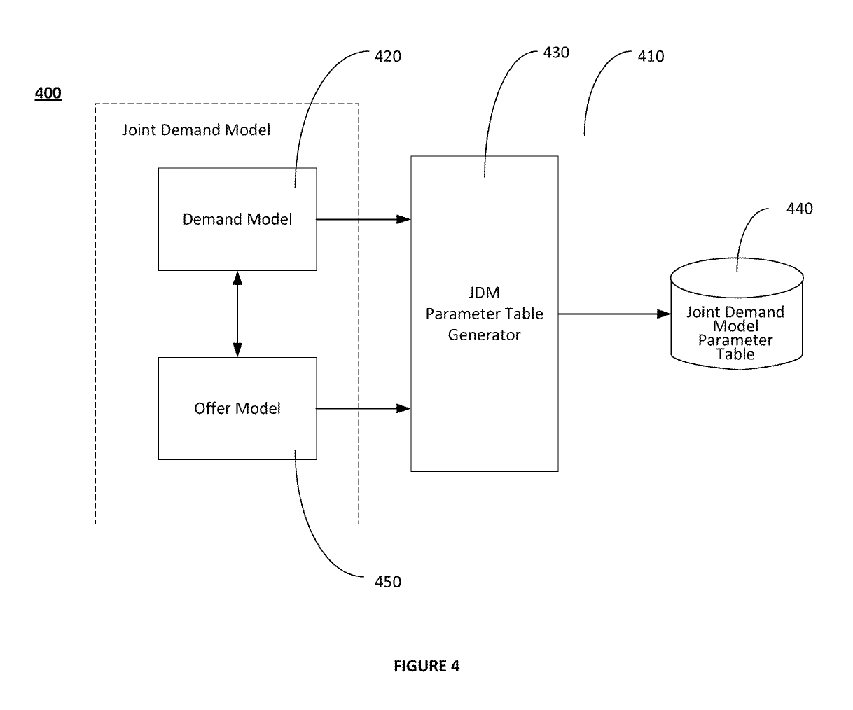

FIG. 4 is a functional block diagram illustrating one embodiment of a system and method 400 for constructing a joint demand model lookup table used to efficiently estimate the parameters of the joint demand model. Although many types of demand models may be used in the system and method for determining pricing recommendations, the particular embodiment shown in FIG. 4 comprises a joint demand model 410 in which both a demand model 420 and an offer model 450 are utilized. In the joint demand model 410, the observed sales transactions are assumed to be win-only transactions 405 resulting from the customer's willingness-to-pay convoluted with the prices offered by the sales person. If the joint demand model 410 accurately reflects the sales process, the distribution of win-only transaction data should closely resemble the distribution predicted by the joint demand model.

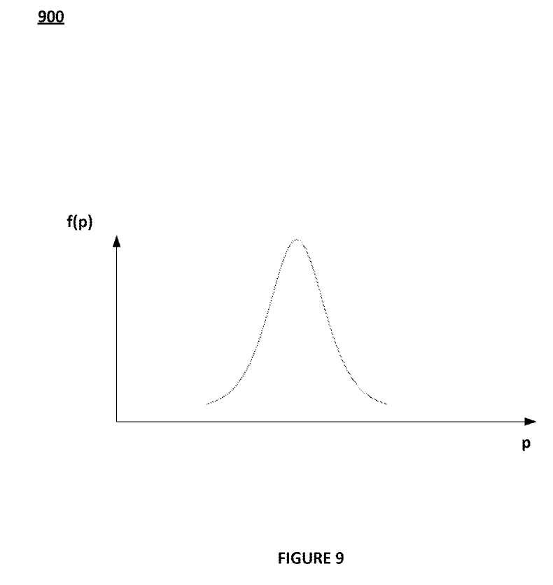

In this particular embodiment of the joint demand model, the buyer is assumed to accept an offer if the offered price is less than the buyer's willingness to pay. The willingness-to-pay of the population of customers is assumed to be distributed according to the logistic distributions. The probability density function of willingness-to-pay distribution can be represented as follows.

$$f ( p ) = \frac{b {e}^{- b ( p - {p}_{0} )}}{{( 1 + {e}^{- b ( p - {p}_{0} )} )}^{2}}$$

Where p is the price and the demand model parameter p₀ represents the mean of the willingness-to-pay distribution and parameter b is proportional to the inverse standard deviation of the willingness-to-pay distribution. FIG. 9 is a graphical representation of the willingness-to-pay probability density function 900.

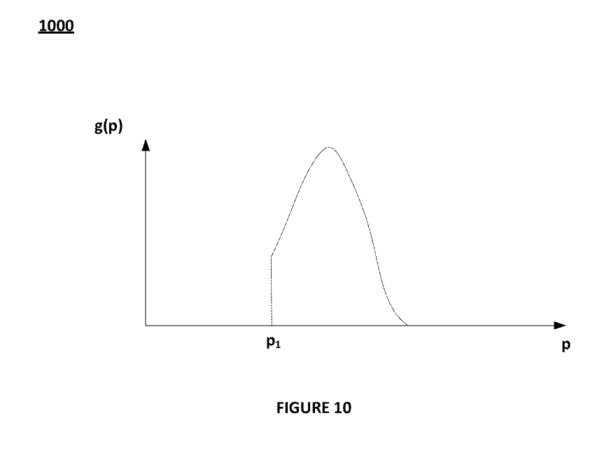

The particular embodiment of the joint demand model 410 assumes an offer model 450 distributed according to a truncated logistic distribution, with the same demand model parameters b and p₀ as the assumed willingness-to-pay distribution. This assumption implies that the salesperson has some knowledge about the willingness-to-pay of the population of customers. In addition, the lower truncation is meant to represent a floor price, where perhaps the cost to produce the product is greater than the price offered. FIG. 10 is a graphical representation of the offer probability density function, where the price p₁ represents the floor on offered prices1000.

The combination of the logistic willingness to pay distribution and the lower truncated logistic offer distribution can be represented by the following probability density function.

$$h ( p ) = \frac{2 {( 1 + {e}^{b ( {p}_{1} - {p}_{0} )} )}^{2} ( b {e}^{b ( p - {p}_{0} )} )}{{( 1 + {e}^{b ( p - {p}_{0} )} )}^{3}}$$

$$for p \geq {p}_{1} else 0$$

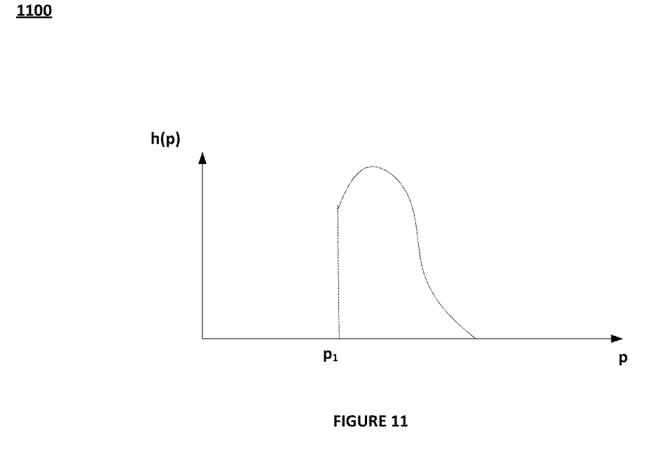

FIG. 11 is a graphical representation of the transaction density implied by the convolution of the logistic willingness-to-pay and the lower truncated logistic offer distributions 1100, where p is the price and the demand model parameter p₀ represents the mean of the willingness-to-pay distribution and parameter b is proportional to the inverse standard deviation of the willingness-to-pay distribution. The price p₁ represents the floor on offered prices.

There are several ways to estimate the demand model parameters b, p₀, and p₁ using win-only data which is assumed to conform to the implied transaction density. Some methods are more numerically efficient than others. For instance, the maximum likelihood approach can be applied, but a closed form solution to the maximum likelihood optimization problem is unknown and the method results in a computationally intensive process. The moment matching technique is another traditional parameter estimation technique. Unfortunately, a closed form solution to the inverse moments formulas are unknown. Fortunately, a JDM parameter table generator 430 can be used to pre-generate a JDM parameter lookup table 440 which is based on the moment matching technique. The JDM parameter lookup table can then be used to find the demand model parameters b, p₀, and p₁ which match the sample moments, such as the sample mean and sample variance, of the observed win-only transaction data. The use of a lookup table results in a much more computationally efficient method than the maximum likelihood approach, where the particular embodiment described assumes that the lower truncation point p₁ is known.

Since a closed form solution for the moments of the assumed transaction density is unknown, another technique must be applied for populating the JDM parameter lookup table. One such technique is the use of Monte Carlo simulation. In this particular embodiment, the joint demand model lookup table generator 430 generates transaction data according to the joint demand model 410 where the parameters b, p₀, and p₁ are known. The sample mean and sample variance of the generated transaction data can be used to approximate the true moments implied by the parameters b, p₀, and p₁, where the precision of the approximation is proportional to the number of transactions generated. In addition, the estimation error associated with the b and p₀ parameters can be determined for a given number of transactions.

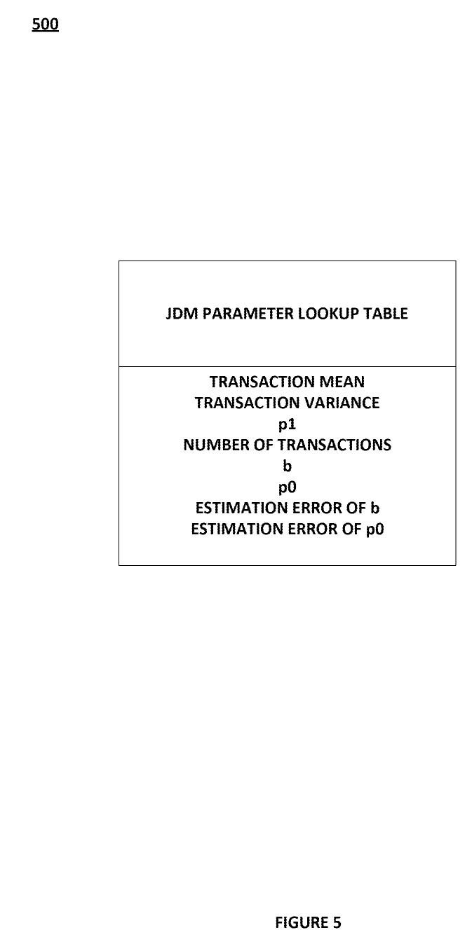

FIG. 5 is a representation of the database table structure of the joint demand model parameters lookup table 500. Fields in the JDM parameter lookup table which are used to lookup the JDM parameter b and p₀ include the transaction sample mean, sample variance, the known JDM parameter p₁, and the number of transactions used to calculate the sample moments. The values returned by the JDM parameter lookup table include the JDM parameters b and p₀ as well as the parameter estimation error of b and p₀. The joint demand model parameter lookup table 500 is used in a numerically efficient algorithm for estimating the price elasticity of demand for each market segment, at each segment level.

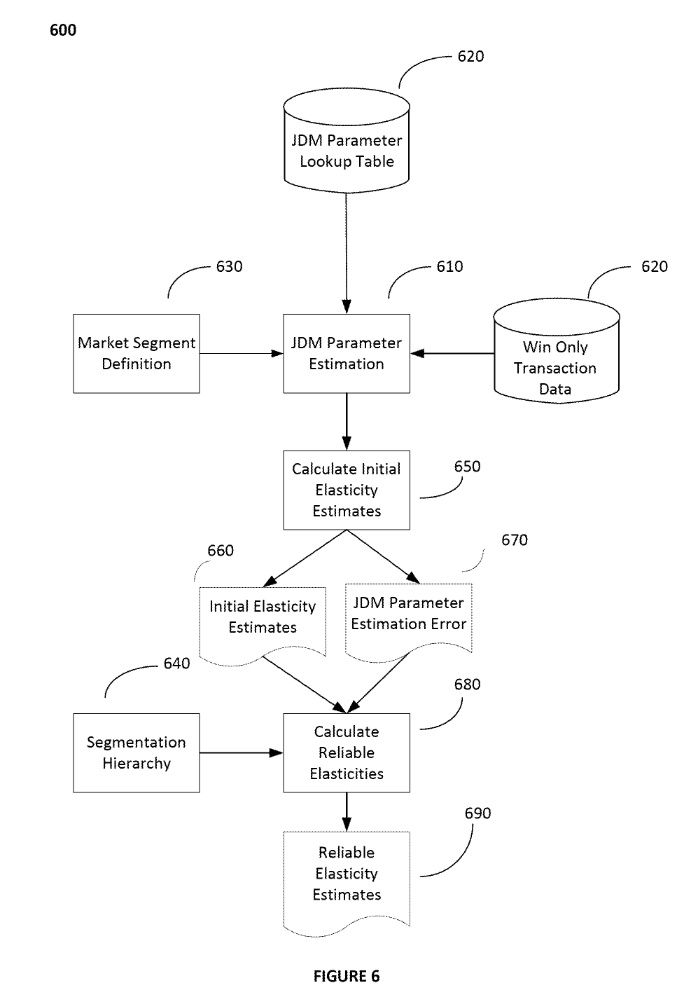

FIG. 6 is a functional block diagram illustrating the elasticity estimator which relies upon a pre-generated joint demand model parameter lookup table. Win-only transaction data 620 is retained in data storage and is used by the joint demand model parameter estimator 610. The joint demand model parameter estimator 610 also uses the market segment definition function 630 and the joint demand model lookup table 615 to compute an estimate of the joint demand model parameters 610 and parameter estimation error for the defined market segments. The joint demand model parameter estimates are used to calculate initial elasticity estimates. Reliable elasticities are calculated 680 using the initial elasticity estimates 660 and the parameter estimation error 670, combined with the segmentation hierarchy 640 to produce the reliable elasticity estimates 690. The reliable elasticities 690 are calculated using a weighting scheme using the segmentation hierarchy 640.

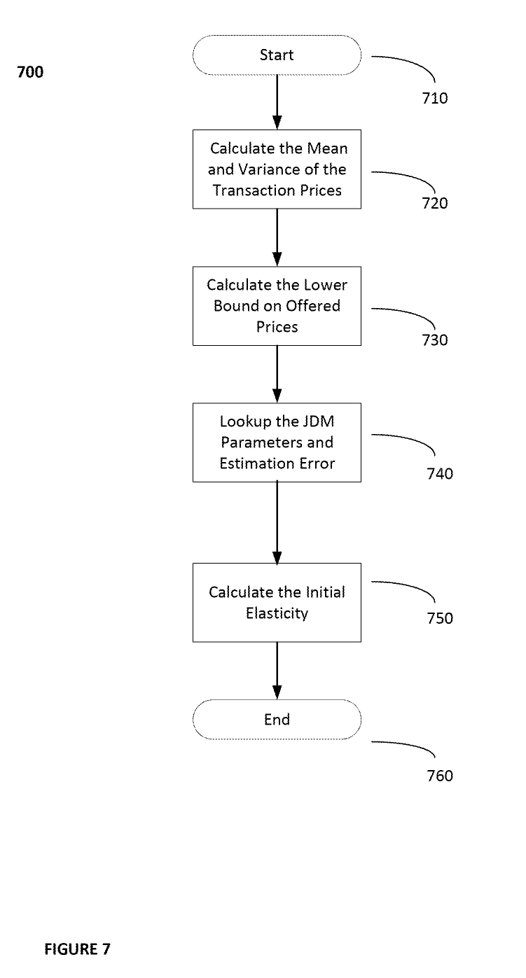

FIG. 7 is a flow diagram representing the JDM parameter estimator. For a defined market segment, the sample mean and sample variance of the transaction prices are calculated. The parameter p₁ is also calculated, where one such method for calculating the lower bound on transaction prices is to take the minimum transaction price in the defined market segment. The sample mean, sample variance, and the lower truncation value are then used to lookup the joint demand model parameters b and p₀ using the joint demand model parameter lookup table. The joint demand model parameter lookup table also provides the estimation error of the joint demand model parameters b and p₀. The elasticity ε at price p₀ can then be calculated using the following well known formula defined for the logistic willingness-to-pay distribution.

$$ɛ = \frac{1}{2} \cdot b \cdot {p}_{0}$$

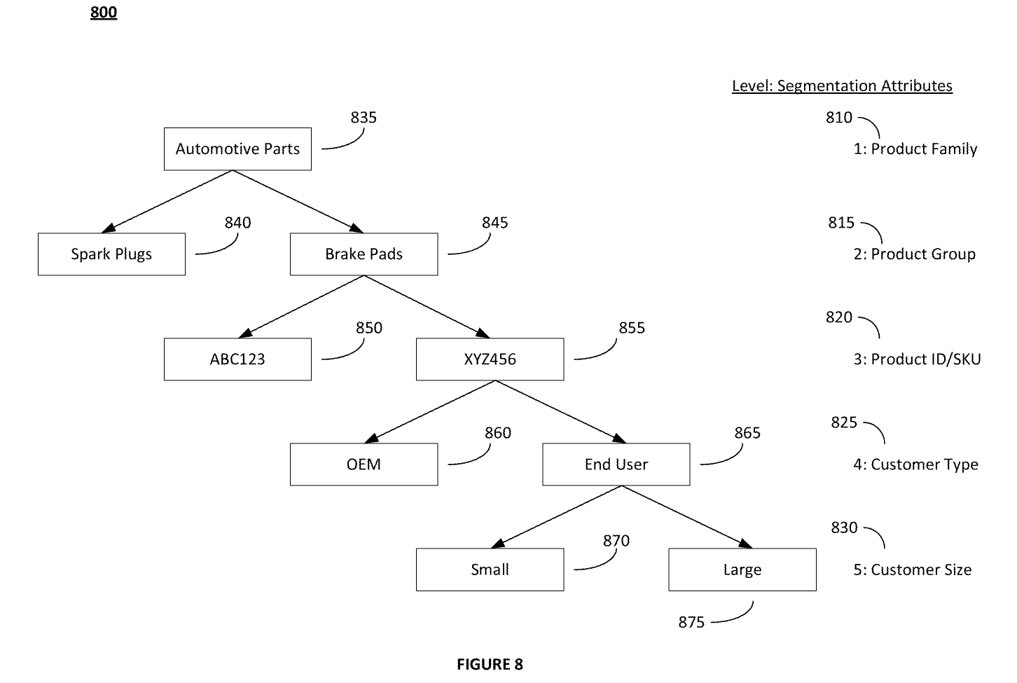

FIG. 8 is an example of a market segmentation hierarchy used in a weighting scheme to calculate reliable elasticities. A segmentation hierarchy 800 is shown for an automotive parts distributor. In this example, the segmentation attributes are set forth in five levels 810, 815, 820, 825, 830 although any number of levels could be part of a segmentation hierarchy. The levels in this example segmentation hierarchy 800 ranging from highest to lowest represent product family 810, product group 815, product SKU 820, customer type 825 and order size 830. The hierarchy structure as defined can also be referred to as a tree, where the highest level attribute such as 810 is referred to as the trunk node and the attributes for level 830 is referred to as leaf node. This example of a segmentation hierarchy consists of three levels that represent product attributes 810-820, one level that represents a customer type attribute 825, and one level that represents an order size attribute 830. However, the segmentation hierarchy may include any number of attributes although only five levels are shown in this example. Further, the attributes may be ordered into levels, where in this example the highest level 810, represents the most important attribute, and lowest level 830 represents the least important. The importance of an attribute can be determined through a number of methods, including but not limited to a statistical analysis of transactional data, or by the expert opinion of a company's sales' executives.

As we progress from the trunk node 835 to the leaf node, at each level of the hierarchy structure, the transaction data is separated to become more granular, but will also become more sparse. As a result, there is less transaction data available for each successively lower node in the tree. For example, the trunk node automotive parts 835 would include all transaction data, but as one moves one level down to the product group nodes 815, the transaction data is split into spark plugs 840 and brake pads 845. As we traverse from the trunk node 835 to the leaf nodes 840-875, there is a tradeoff between the amounts of transaction data available at a node versus the level of segmentation granularity at each node. Elasticities are estimated at each level using the elasticity estimator described in FIG. 6. Elasticities estimated at higher levels use more data and therefore have a lower estimation error, resulting in a higher confidence in the estimated value. Elasticities estimated at a lower level use less data and therefore have a higher estimation error, resulting in a lower confidence in the estimated value. On the other hand, the elasticities estimated at a lower level have a higher specificity since the data used to estimate the elasticities are more specific to the specific market segment.

To estimate a reliable elasticity at the lowest level of the segmentation hierarchy, a weighted average can be calculated along each traverse of the tree from trunk node to leaf node at the lowest level of the segmentation hierarchy. The weighting scheme used must balance the tradeoff between confidence and specificity. The functions below represent once such embodiment of the two weighting rules.

$$Confidence Weight \text{:} {w}_{1} = \frac{1}{estimation error of b parameter}$$

$$Specificity Weight \text{:} {w}_{2} = Hierarchy level$$

$$Combined Weight \text{:} {w}_{combined} = {w}_{1} \cdot {w}_{2}$$

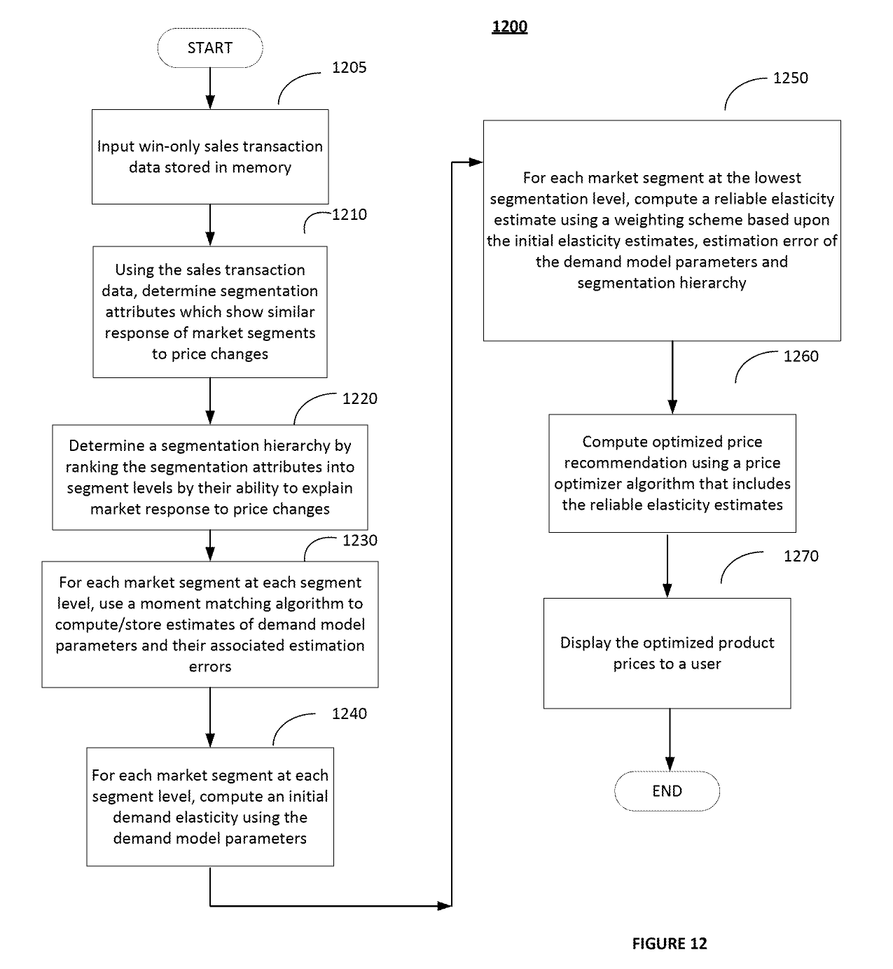

FIG. 12 is a flow diagram of an exemplary embodiment of the method for determining optimized product price recommendations 1200. The method is implemented by computer-executable instructions being executed by a computer processor. Sales transaction data stored in memory for one or more products is inputted 1205. The sales transaction data comprises observed win-only sales transactions for a business. Using the sales transactions, segmentation attributes are determine which define market segments that have similar responses to product price changes 1210. The segmentation attributes are then ranked into a segmentation hierarchy based on the segmentation attributes ability to explain the market response to price changes 1220. The segmentation hierarchy defines market segments at each level in the hierarchy. For each market segment at each segment level, use a moment matching algorithm to compute and store estimates of the demand model parameters and compute and store their associated estimation error 1230. For each market segment at each segment level, compute an initial demand elasticity using the demand model parameters 1240. For each market segment at the lowest segmentation level, compute a reliable elasticity estimate using a weighting scheme based upon the initial elasticity estimates, the estimation error of the demand model parameters, and the segmentation hierarchy 1250. Optimized price recommendations are computed using a price optimizer algorithm that includes the reliable elasticity estimates 1260. The product price recommendations are then displayed to the users 1270.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Although the present invention has been described in detail with reference to certain preferred embodiments, it should be apparent that modifications and adaptations to those embodiments might occur to persons skilled in the art without departing from the spirit and scope of the present invention.

1. A computer-implemented method for determining optimized product price recommendations, the method implemented by computer-executable instructions being executed by a computer processor comprising the steps of:
inputting sales transaction data stored in memory for one or more products, the sales transaction data comprising win-only sales transactions for a business;
computing market segments that have similar responses to product price changes by computing a ranking of market segment attributes using price sensitivity data and the sales transaction data;
using the market segment ranking, grouping the market segments into a market segment hierarchy;
computing a set of estimated model parameters for each market segment in the market segment hierarchy;
computing a customer demand model with customer demand model parameters for the market segment in the market segment hierarchy and storing the customer demand model parameters in a data storage system;
computing and storing an estimation error for the customer demand model parameters for the market segment in the market segment hierarchy;
computing an initial demand elasticity for the market segment in the market segment hierarchy using the customer demand model parameters;
computing a reliable elasticity estimate for the market segment at a lowest level in the market segment hierarchy using the computed initial demand elasticity and customer demand model parameter estimation error; and
computing optimized product price recommendations using a price optimizer algorithm that includes the reliable elasticity estimate.

2. The method of claim 1 further comprising the step of displaying the optimized product price recommendations to a user.

3. The method of claim 1 wherein in computing a customer demand model step the customer demand model is computed using a moment matching algorithm, the market segments, the sales transaction data and the estimated model parameters.

4. The method of claim 1, wherein in the grouping the market segments into a market segment hierarchy step, levels of the market segment hierarchy are selected from the group consisting of products, product types, product numbers, customer and customer segments.

5. The method of claim 1, wherein in the computing market segments that have similar responses to product price changes step, the market segmentation attributes are selected from the group consisting of products, customer orders, customer type and customer geographical location.

6. The method of claim 1 wherein in computing the market segment that have similar responses to product price change step, price sensitivity is determined by how closely the segment attributes model the win-only transactions.

7. The method of claim 1 wherein in the storing the customer demand model parameters in a data storage system step, the customer demand model parameters are stored in a lookup table organized by market segment and market segment hierarchy.

8. The method of claim 1 wherein in the computing a customer demand model step, the customer demand model comprises jointly computing a demand model and an offer distribution model.

9. The method of claim 1 wherein in the computing a customer demand model step, the customer demand model is a joint demand model comprising a demand model and an offer distribution model.

10. A computer system comprising:
a processor;
a memory coupled to the processor;
a display device;
wherein the memory stores a program that, when executed by the processor causes the processor to:
input sales transaction data stored in memory for one or more products, the sales transaction data comprising win-only sales transactions for a business;
compute market segments that have similar responses to product price changes by computing a ranking of market segment attributes using price sensitivity data and the sales transaction data;
using the market segment ranking, group the market segments into a market segment hierarchy;
compute a set of estimated model parameters for each market segment in the market segment hierarchy;
compute a customer demand model with customer demand model parameters for the market segment in the market segment hierarchy and storing the customer demand model parameters in a data storage system;
compute and store an estimation error for the customer demand model parameters for the market segment in the market segment hierarchy;
compute an initial demand elasticity for the market segment in the market segment hierarchy using the customer demand model parameters;
compute a reliable elasticity estimate for the market segment at a lowest level in the market segment hierarchy using the computed initial demand elasticity and customer demand model parameter estimation error; and
compute optimized product price recommendations using a price optimizer algorithm that includes the reliable elasticity estimate.

11. The system of claim 10 further comprising displaying the optimized product price recommendations to a user on the display device.

12. The system of claim 10 wherein the customer demand model is computed using a moment matching algorithm, the market segments, the sales transaction data and the estimated model parameters.

13. The system of claim 10, wherein the market segments that are grouped into the market segment hierarchy have levels selected from the group consisting of products, product types, product numbers, customer and customer segments.

14. The system of claim 10, wherein the market segmentation attributes are selected from the group consisting of products, customer orders, customer type and customer geographical location.

15. The system of claim 10 wherein price sensitivity is determined by how closely the segment attributes model the win-only transactions.

16. The system of claim 10 wherein the customer demand model parameters are stored in a lookup table organized by market segment and market segment hierarchy.

17. The system of claim 10 wherein the customer demand model comprises jointly computing a demand model and an offer distribution model.

18. The system of claim 10 the customer demand model is a joint demand model comprising a demand model and an offer distribution model.

19. A computer-implemented method for determining optimized product price recommendations, the method implemented by computer-executable instructions being executed by a computer processor comprising the steps of:
inputting sales transaction data stored in memory for one or more products, the sales transaction data comprising win-only sales transactions for a business;
computing market segments that have similar responses to product price changes by computing a ranking of market segment attributes using price sensitivity data and the sales transaction data;
using the market segment ranking, grouping the market segments into a market segment hierarchy;
computing a set of estimated model parameters for each market segment in the market segment hierarchy;
using a moment matching algorithm, the market segments, the sales transaction data and the estimated model parameters, computing a customer demand model with customer demand model parameters for the market segment in the market segment hierarchy and storing the customer demand model parameters in a data storage system;
computing and storing an estimation error for the customer demand model parameters for the market segment in the market segment hierarchy;
computing an initial demand elasticity for the market segment in the market segment hierarchy using the customer demand model parameters;
computing a reliable elasticity estimate for the market segment at a lowest level in the market segment hierarchy using the computed initial demand elasticity and customer demand model parameter estimation error;
computing optimized product price recommendations using a price optimizer algorithm that includes the reliable elasticity estimate; and
displaying the optimized product price recommendations to a user.

20. A computer-implemented method for determining optimized product price recommendations, the method implemented by computer-executable instructions being executed by a computer processor comprising the steps of:
inputting sales transaction data stored in memory for one or more products, the sales transaction data comprising win-only sales transactions for a business;
using the sales transaction data, determining segmentation attributes, the segmentation attributes representing market segments with similar responses to price changes;
determining a segmentation hierarchy by ranking the segmentation attributes into market segment levels by their ability to explain market response to price changes;
for each market segment at each market segment level:
using a moment matching algorithm to compute and store estimates of demand model parameters and associated demand model parameters estimation errors;
computing an initial demand elasticity using the demand model parameters; and
computing a reliable elasticity estimate using a weighting scheme based upon the initial demand elasticity, the demand model parameter estimation errors and the segmentation hierarchy;
computing an optimized product price recommendation using a price optimizer algorithm that includes the reliable elasticity estimates; and
making the optimized product prices available to a user.
